(19) United States
(12) Patent Application Publication
(10) Pub. No.: US 2012/0293110 A1
(43) Pub. Date: Nov. 22, 2012

(54) ELECTRODE, FUEL CELL AND BATTERY

(76) Inventors: Spruce Frederick, Northwich (GB); Judith Ann West, Northwich (GB); Gillian Mary Greenwood, Northwich (GB)

(21) Appl. No.: 13/483,952

(22) Filed: May 30, 2012

Related U.S. Application Data
(63) Continuation of application No. PCT/GB2010/052004, filed on Dec. 1, 2010.

(51) Int. Cl. H01M 8/22; H02J 7/00

(52) U.S. Cl. 320/101; 429/405

(57) ABSTRACT

An aluminium electrode for use in an aluminium-air fuel cell. The aluminium electrode includes at least two long dimensions and at least two sides formed by the at least two long dimensions. At least one side includes at least one partially disrupted surface.

### CROSS-REFERENCE TO RELATED APPLICATION

This application is a continuation of and claims the priority benefit of PCT Patent Application Serial No. PCT/GB2010/052004, filed Dec. 1, 2010, which is hereby incorporated herein by reference.

### FIELD OF THE INVENTION

The present invention relates to an electrode, a fuel cell and a battery. In particular, the present invention relates to an aluminium electrode for use in an aluminium-air fuel cell, to an aluminium-air fuel cell, to a battery comprising an aluminium-air fuel cell, and to a method of operating the same.

### BACKGROUND OF THE INVENTION

Aluminium-air fuel cells have been known for a number of years. In particular, a large amount of research has been conducted into the design of commercially useful cells. The electrochemical and chemical reactions taking place in the fuel cell are as follows:

### Anode Reaction

Al+NaOH+3OH⁻→NaAl(OH)₄+3e⁻

### Cathode Reaction

3e⁻+1½H₂O+¾O₂→3OH⁻

### Nett Cell Reaction

Al+NaOH+1½H₂O+¾O₂→NaAl(OH)₄

Without wishing to be bound by theory, in this context polarisation is understood to be the generation of a potential in the cell which acts against the working potential, thereby reducing the overall cell potential, particularly under higher loads. It is considered that one of the contributory factors to polarisation is the following parasitic reaction that occurs between the aqueous electrolyte used in aluminium-air fuel cells and the aluminium anode:

### Parasitic Anode Reaction

6Al+6H₂O→2Al(OH)₃+H₂⇑

Therefore, it is desired to improve the current designs of fuel cells and batteries.

### SUMMARY OF THE INVENTION

According to a first aspect of the invention there is provided an aluminium electrode for use in an aluminium-air fuel cell, the aluminium electrode comprising two sides formed from the two longest dimensions of the electrode, wherein at least one side of the electrode comprises an at least partially disrupted surface.

Disrupting the surface of the side of the electrode helps to reduce polarisation and as a result enables a higher voltage to be obtained from fuel cells incorporating the electrode. Without wishing to be bound by theory, it is thought that the disruption of the surface of the side of the electrode improves gas (H₂) disengagement from the surface, and mitigates the build up of solid particles on the effective surface of the electrode.

Typically the aluminium electrode is wedge-shaped, most typically comprising a top side and a bottom side, said top side being of a greater width than said bottom side, thereby forming said wedge-shape.

Preferably the aluminium electrode comprises one or more grooves or the like traversing from the top side to the bottom side.

At least one side of the aluminium electrode may comprise one or more grooves or the like traversing the side longitudinally or latitudinally.

In the context of the present invention, “grooves or the like” includes: corrugated or undulating surfaces; U-shaped and V-shaped grooves; slotted or slatted shapes including louvers and blades; rods; wires and score lines.

Typically the aluminium electrode comprises a plurality of grooves or the like. The grooves or the like may be substantially parallel.

Typically the grooves or the like have a width of from about 1 mm to about 12 mm.

The grooves or the like may have a depth of from about 0.5 mm to about 4 mm.

The distance between the grooves or the like may be from about 4 mm to about 5 mm.

Preferably the grooves or the like are V-shaped grooves. The V-shaped grooves are shown to be particularly good at mitigating the effects of polarisation.

The V-shaped grooves may have a width of from about 1.5 mm to about 4 mm.

Typically, the V-shaped grooves have a depth of from about 1.5 mm to about 3 mm.

In an alternative embodiment, the aluminium electrode comprises one or more apertures between the two sides of the electrode.

The apertures can be longitudinal or latitudinal slots; substantially circular perforations; or hexagonal, or some other geometrically shaped, holes.

Typically, the apertures are longitudinal or latitudinal slots. The slots may comprise from about 5% to about 10% of the area of one side of the electrode.

Alternatively, the apertures are substantially circular. The substantially circular apertures may comprise from about 10% to about 12% of the area of one side of the electrode.

The aluminium electrode may further comprise a tin dopant, and a further dopant selected from one or more of the group consisting of: gallium, indium, thallium and phosphorus.

Suitable dopants for the aluminium electrode include: group III elements, such as tin; group IV elements, such as gallium, indium and thallium; and group V elements, such as phosphorus.

Typically the further dopant is present in an amount of up to approximately 0.05% w/w.

According to a second aspect of the invention there is provided an aluminium-air fuel cell comprising an aluminium anode and an air cathode located in an electrolyte chamber, the aluminium anode comprising an aluminium electrode as described herein, in particular in the first aspect.

Typically the aluminium-air fuel cell comprises two air cathodes having the aluminium anode located therebetween, and substantially parallel thereto.

The inter-electrode gap between the aluminium anode and the adjacent air cathodes may be from about 1 mm to about 2 mm.

Typically the aluminium-air fuel cell as claimed comprises two air distributors having the two air cathodes and the aluminium anode located therebetween, and substantially parallel thereto.

The gap between the air distributors and the adjacent air cathodes may be from about 4 mm to about 5 mm.

Using inter-electrode gaps and air gaps as described above helps to reduce voltage loss in the cell.

The aluminium-air fuel cell may further comprise an electrolyte, the electrolyte comprising a compound selected from one or more of the group consisting of: group I hydroxides, including sodium hydroxide and potassium hydroxide; aluminium hydrate (hydrargyllite); and group I halides, including sodium chloride but excluding sodium fluoride.

The electrolyte may comprise a seeding agent selected from one or more of the group consisting of: group I phosphates, including sodium phosphate; group I sulphates, including sodium sulphate; group I halides, including sodium fluoride but excluding sodium chloride; and group I carbonates, including sodium bicarbonate. The electrolyte may further comprise at least one of sodium hydroxide and potassium hydroxide in a concentration of from about 4M to about 8M.

According to a third aspect of the invention there is provided a battery comprising two or more of the aluminium-air fuel cells as described herein, in particular in the second aspect.

Typically the battery further comprises a filter configured to remove suspended solids, said filter being fluidly connected to the electrolyte chamber.

Optionally, the filter is a crossflow filter.

Advantageously the battery further comprises a precipitator configured to precipitate hydrargyllite, said precipitator being fluidly connected to the electrolyte chamber.

Typically the precipitator comprises a hydrargyllite seeding agent for promoting the precipitation of hydrargyllite.

The battery may further comprise a reserve power source electronically attached to the battery for providing power to a load while the aluminium-air fuel cells are being activated or serviced.

Optionally, the battery further comprises an activation mechanism configured to activate the aluminium-air fuel cells to power said load, after a period of supplying power from the reserve power source.

Optionally, the battery further comprises a charging mechanism configured to recharge the reserve power source using power supplied by the active aluminium-air fuel cells.

In this way, the battery can be operated continuously without external power, the reserve power source providing power for periods when the aluminium-air cells are being re-charged with new anodes and starting up. The reserve power source can be a lead-acid battery.

The battery may be pivotally mounted on a mounting bracket assembly.

The pivotally mounted battery can pivot around the axis on which it is mounted. This enables the battery to remain operational even when it is held at an angle. For example, when the battery is placed in a car it will experience inclines and declines as the car ascends and descends. The force of gravity will pivot the pivotally mounted battery when subject to inclines and declines such that the battery remains substantially vertical. Thus, the tilting mechanism allows the battery to maintain a substantially vertical orientation when it is subject to inclines and declines.

Moreover, the tilting mechanism allows the battery to be cleaned (i.e., removal of precipitates from a sump at the bottom of the battery) with reduced downtime.

According to a fourth aspect of the invention there is provided a method of operating a battery comprising an aluminium-air fuel cell comprising the steps of:

providing a battery as described herein, in particular in the third aspect;

providing an air flow to the air cathode;

providing electrolyte to the electrolyte chambers;

and maintaining a flow of electrolyte.

The method may comprise the further step of activating the aluminium-air fuel cell using a reserve power source.

The method may comprise the further step of pre-heating the electrolyte.

Typically the method comprises the further step of adding a seeding agent to the electrolyte.

Advantageously, the method comprises the further step of oscillating the flow of electrolyte to inhibit flocculation of precipitates therein.

The method may comprise the further steps of monitoring the output of the battery and shutting down the aluminium-air fuel cells when the output falls below a pre-set threshold value.

Typically, the output monitored is the voltage output.

The method may comprise the further step of switching on a reserve power source when the aluminium-air fuel cells are shutdown.

Optionally the method comprises the further step of restarting the battery using the reserve power source.

Optionally the method comprises the further step of recharging the reserve power source using the battery.

This allows the battery to remain operational whilst the aluminium anodes are replaced. The battery can keep the reserve power source at a set level of charge during operation. When the aluminium anodes need replaced, the reserve power source can provide power. Once the aluminium anodes are replaced, the reserve power source can be switched off and recharged using the battery.

Typically the air flow is provided at a rate of from about 1 to about 3 litres per minute.

The electrolyte flow may be provided at a rate of from about 0.5 to about 2.5 litres per minute.

According to a fifth aspect of the invention there is provided an aluminium electrode for use in an aluminium-air fuel cell, the aluminium electrode comprising a tin dopant, and a further dopant selected from one or more of the group consisting of: gallium, indium, thallium and phosphorus.

Typically the further dopant is present in an amount of up to approximately 0.05% w/w.

According to a sixth aspect of the invention there is provided an aluminium-air fuel cell comprising an aluminium anode and two air cathodes located in an electrolyte chamber, the aluminium anode being located between the two air cathodes, and substantially parallel thereto, wherein the inter-electrode gap between the aluminium anode and the adjacent air cathodes is from about 1 mm to about 2 mm.

The aluminium-air fuel cell may comprise two air distributors having the two air cathodes and the aluminium anode located therebetween, and substantially parallel thereto.

Typically the gap between the air distributors and the adjacent air cathodes is from about 4 mm to about 5 mm.

The aluminium-air fuel cell may further comprise an electrolyte, the electrolyte comprising a compound selected from one or more of the group consisting of: group I hydroxides, including sodium hydroxide and potassium hydroxide; aluminium hydrate (hydrargyllite); and group I halides, including sodium chloride but excluding sodium fluoride.

The electrolyte may also comprise a seeding agent selected from one or more of the group consisting of: group I phosphates, including sodium phosphate; group I sulphates, including sodium sulphate; group I halides, including sodium fluoride but excluding sodium chloride; and group I carbonates, including sodium bicarbonate.

The electrolyte may further comprise at least one of sodium hydroxide and potassium hydroxide in a concentration of from about 4M to about 8M.

According to a seventh aspect of the invention there is provided an aluminium-air fuel cell comprising an aluminium anode and an air cathode located in an electrolyte chamber, and an electrolyte wherein the electrolyte further comprises a seeding agent selected from one or more of the group consisting of: group I phosphates, including sodium phosphate; group I sulphates, including sodium sulphate; group I halides, including sodium fluoride but excluding sodium chloride; and group I carbonates, including sodium bicarbonate.

Typically the electrolyte comprises a compound selected from one or more of the group consisting of: group I hydroxides, including sodium hydroxide and potassium hydroxide; aluminium hydrate (hydrargyllite); and group I halides, including sodium chloride but excluding sodium fluoride.

The electrolyte may further comprise at least one of sodium hydroxide and potassium hydroxide in a concentration of from about 4M to about 8M.

According to an eighth aspect of the invention there is provided a battery comprising two or more aluminium-air fuel cells and a filter, said aluminium-air fuel cells comprising an aluminium anode and an air cathode located in an electrolyte chamber, wherein the filter is fluidly connected to the electrolyte chamber, and is configured to remove suspended solids from the electrolyte.

Optionally the filter is a crossflow filter.

The battery may further comprise a precipitator configured to precipitate hydrargyllite, said precipitator being fluidly connected to the electrolyte chamber.

Typically the precipitator comprises a hydrargyllite seeding agent for promoting the precipitation of hydrargyllite. The battery may comprise a reserve power source electronically attached to the battery.

The battery may further comprise an activation mechanism configured to initiate the aluminium-air fuel cells, and being electronically attached thereto.

The battery may be pivotally mounted on a mounting bracket assembly.

According to a ninth aspect of the invention there is provided a battery comprising two or more aluminium-air fuel cells, said aluminium-air fuel cells comprising an aluminium anode and an air cathode located in an electrolyte chamber, wherein the battery is pivotally mounted on a mounting bracket assembly.

The battery may further comprise a filter wherein said filter is fluidly connected to the electrolyte chamber, and is configured to remove suspended solids from the electrolyte.

Optionally, the filter is a crossflow filter.

The battery may further comprise a precipitator configured to precipitate hydrargyllite, said precipitator being fluidly connected to the electrolyte chamber.

Typically the precipitator comprises a hydrargyllite seeding agent for promoting the precipitation of hydrargyllite.

The battery may comprise a reserve power source electronically attached to the battery.

The battery may comprise an activation mechanism configured to initiate the aluminium-air fuel cells, and being electronically attached thereto.

Preferred, alternative, optional and typical features of each aspect of the invention are, where appropriate, as for each other aspect mutatis mutandis.

### BRIEF DESCRIPTION OF THE DRAWINGS

The present invention will now be described, by way of example only, with reference to the following Figures in which:

FIG. 1 is a plan-view of an aluminium-air fuel cell;

FIG. 2 is schematic diagram (not to scale) which shows the component spacing in an aluminium-air fuel cell in mm;

FIG. 3 is a schematic cross-section of an aluminium-air fuel cell;

FIG. 4a is a graph which shows the conductivity of the aluminium electrodes of the invention against the dissolved aluminate at various concentrations of potassium hydroxide electrolyte;

FIG. 4b is a graph which shows the voltage of the aluminium electrodes of the invention against the dissolved aluminate at various concentrations of potassium hydroxide electrolyte;

FIGS. 5a to 5h are examples of embodiments of aluminium electrodes in accordance with the invention;

FIGS. 6a to 6d are examples of embodiments of aluminium electrodes in accordance with the invention;

FIGS. 7a and 7b are examples of prior art electrodes;

FIG. 8 is a graph that illustrates the cell load against the cell voltage for various aluminium electrodes according to the invention with reference to two prior art electrodes;

FIG. 9 is a graph that illustrates the current density against time for aluminium electrodes doped with various dopants;

FIG. 10 is a simplified diagram of a battery in accordance with an embodiment of the invention; and

FIG. 11 is a block schematic diagram of a self-contained power supply module incorporating the battery of FIG. 10, in different modes of operation (a) to (d).

### DETAILED DESCRIPTION OF THE EXEMPLARY EMBODIMENTS

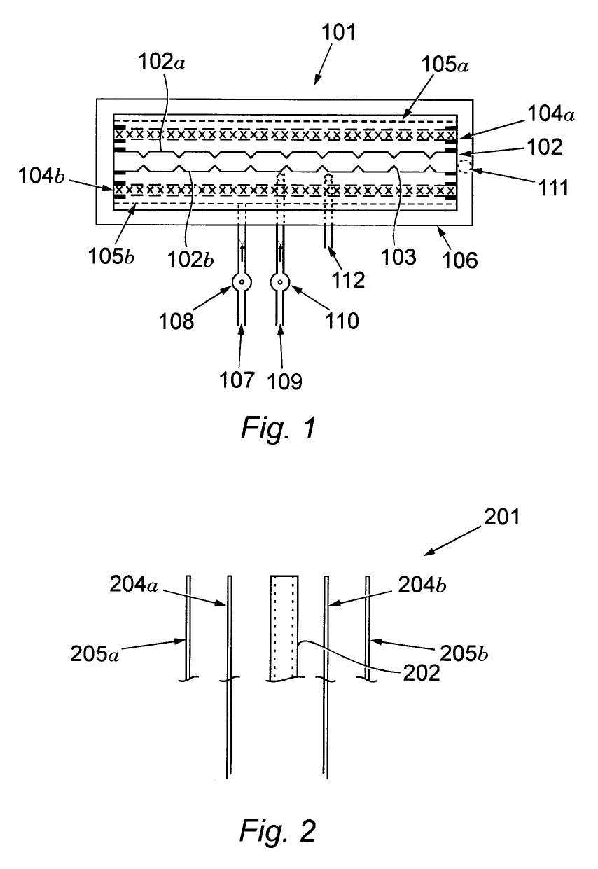

With reference to FIG. 1, there is shown at 101 a plan view of an aluminium-air fuel cell in accordance with one embodiment of the invention. In the centre of the fuel cell 101 there is located an aluminium electrode 102 (the anode) having two sides 102a and 102b formed from the two longest dimensions of the electrode. Sides 102a and 102b contain a plurality of substantially equidistant V-shaped grooves 103 which traverse the sides 102a and 102b in a substantially parallel manner. The V-shaped grooves 103 are a type of corrugation that creates an at least partially disrupted surface.

Also illustrated in FIG. 1 are two air cathodes 104a and 104b and two slotted/perforated air distributors 105a and 105b. The air cathodes 104a and 104b are of the type known in the art comprising an expanded nickel mesh for current collection. The air cathodes may comprise further components such as platinum or other precious metals and/or oxygen reduction catalysts. Alternatively, the air cathodes may further comprise macrocyclic compounds or transition metal spinel-type oxides.

The two air cathodes 104a and 104b and the two slotted/perforated air distributors 105a and 105b are located in a polypropylene cell case 106 which acts as an electrolyte chamber. An air inlet 107 equipped with an air blower 108 feeds air into the air distributors 105a and 105b. Furthermore, an electrolyte feed 109 equipped with an electrolyte pump 110 feed electrolyte into the electrolyte chamber 106. Any excess electrolyte can exit the electrolyte chamber 106 via the electrolyte overflow 111. Also shown in FIG. 1 is an outlet 112 for oxygen-depleted air.

The V-shaped grooves or grooves or the like may traverse the side of the electrode in a longitudinal or latitudinal manner depending on the relative height and length of the electrode as manufactured for use in a particular cell. The electrode may comprise one or more V-shaped grooves or the like, and advantageously comprises a plurality thereof. In the context of the present invention, “grooves or the like” includes: corrugated or undulating surfaces; U-shaped and V-shaped grooves; slotted or slatted shapes including louvers and blades; rods; wires and score lines.

Disrupting the surface of the side of the electrode helps to reduce polarisation and as a result enables a higher voltage to be obtained from fuel cells incorporating the electrode. Without wishing to be bound by theory, it is thought that the disruption of the surface of the side of the electrode improves gas (H₂) disengagement from the surface, and mitigates the build up of solid particles on the effective surface of the electrode.

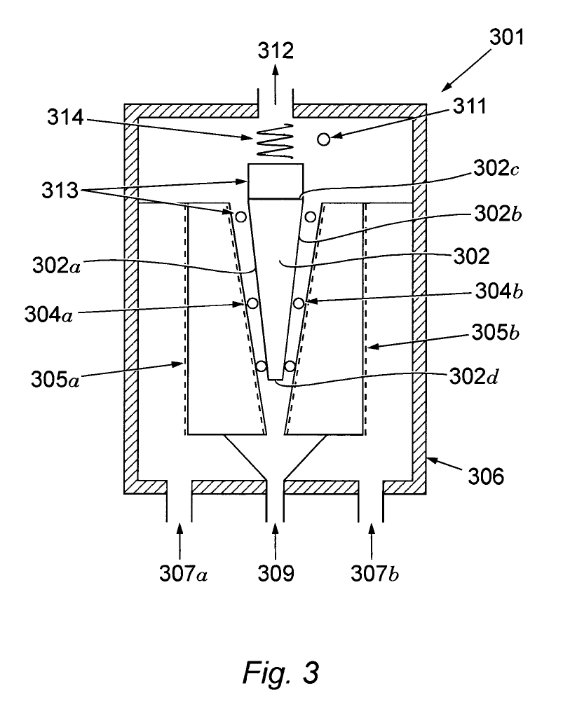

Referring now to FIG. 2, there is shown at 201 a side-on schematic view of an aluminium-air fuel cell showing two air distributors 205a and 205b having two air cathodes 204a and 204b and an aluminium electrode 202 (anode) located therebetween and substantially parallel thereto. The aluminium electrode 202 is 8 mm in width but may vary from around 8 mm to around 12 mm in width. Also, the height and length of the aluminium electrode is 20 cm×20 cm. The air cathodes 204a and 204b are 0.7 mm in width but may vary from about 0.5 mm to about 0.7 mm in width. The height and width of the air cathodes 204a and 204b is 20 cm×20 cm. The inter-electrode gap between the aluminium electrode 202 and the air cathodes 204a and 204b is about 1.5 mm, but may vary from about 1 mm to about 2 mm. The gap between the air cathodes and the adjacent air distributors is about 4 mm, but may vary from about 4 mm to about 5 mm.

The expected output of the cell described above is a power density of 80 to 120 W per kg of aluminium, with an energy density of 180 to 250 Wh per kg of aluminium at a current density of 1 to 2 KA per m².

In an alternative embodiment, an aluminium-air fuel cell as described herein but with conventional flat electrodes includes an inter-electrode gap between the aluminium electrode and the air cathodes of from about 1 mm to about 2 mm.

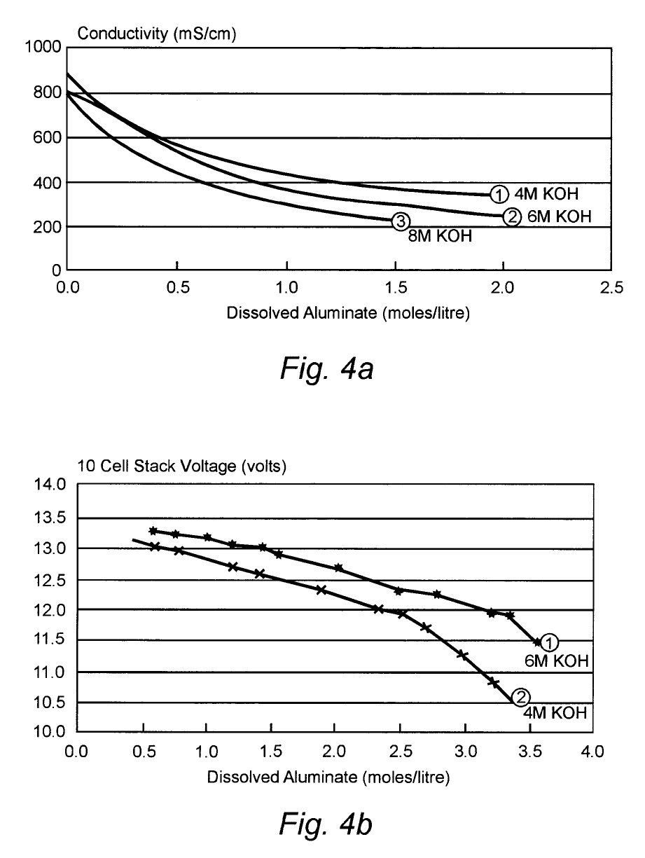

Referring now to FIG. 3, there is shown at 301 a schematic cross-section of an aluminium-air fuel cell having a wedge-shaped aluminium electrode 302 (anode) having a top side 302c and a bottom side 302d, the top side 302c being of a greater width than the bottom side 302d, thereby forming a wedge-shape. On the tapered sides 302a and 302b of the wedge-shaped electrode are V-shaped grooves (not shown) which traverse the sides 302a and 302b in a substantially parallel manner. The V-shaped grooves are a type of corrugation that creates an at least partially disrupted surface.

Also illustrated in FIG. 3 are two air cathodes 304a and 304b and two air diffusers 305a and 305b. The air cathodes 304a and 304b are of the type known in the art comprising an expanded nickel mesh for current collection. The air cathodes may comprise further components such as platinum or other precious metals and/or oxygen reduction catalysts.

Alternatively, the air cathodes may further comprise macrocyclic compounds or transition metal spinel-type oxides.

The two air cathodes 304a and 304b and two air diffusers 105a and 105b are located in a PVC casing 306 which acts as an electrolyte chamber. Air inlets 307a and 307b allow air to access the air cathodes 304a and 304b. Also, inlet 309 allows electrolyte comprising 4M potassium hydroxide into the electrolyte chamber 306. The electrolyte also contains sodium fluoride which acts as a seeding agent, encouraging the precipitation of aluminium hydrate out of the electrolyte. The electrolyte can exit the chamber 306 into an electrolyte reservoir (not shown) via the electrolyte outlet 311.

Also shown in FIG. 3 is an outlet 312 for oxygen depleted air, Teflon® spacers 313 for spacing the aluminium electrode 302 and the air cathodes 304a and 304b at a pre-defined gap, and a preloaded spring 314 for biasing the aluminium electrode 302 towards the bottom of the chamber 306. As the aluminium electrode 302 is consumed in the electrochemical reaction, it is pushed towards the bottom of the chamber 306.

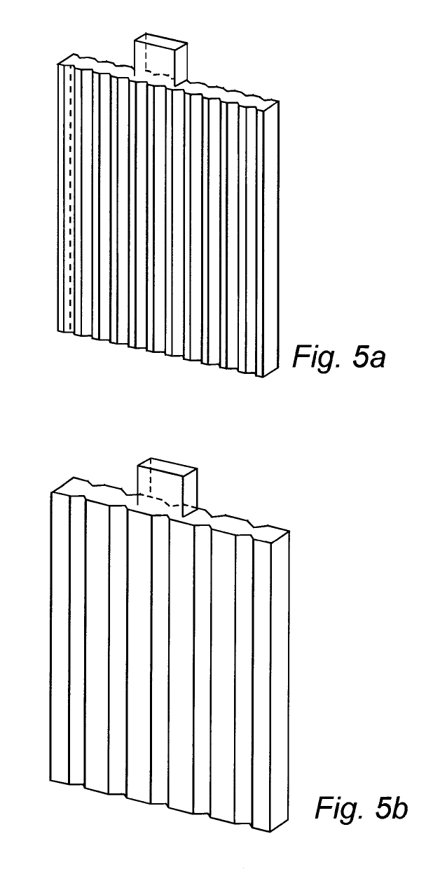

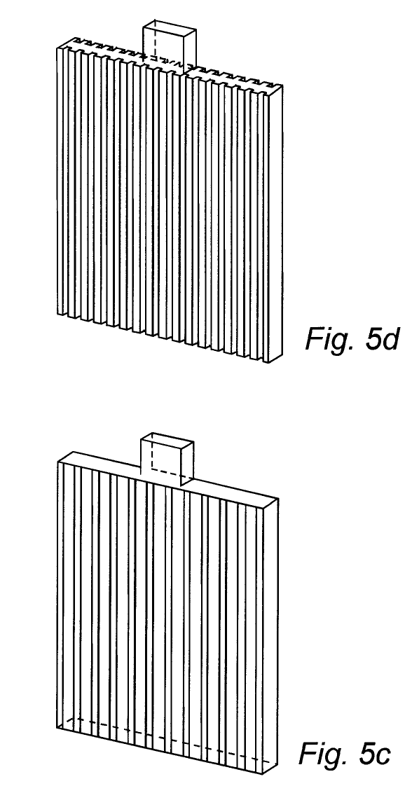

The electrolyte described above comprises 4M potassium hydroxide, but can also suitably comprise from 4M to 8M potassium hydroxide. FIG. 4a shows a graph of conductivity of the aluminium electrodes against the dissolved aluminate using 4M, 6M and 8M potassium hydroxide in the electrolyte at 60° C. The conductivity is higher in electrolytes with 4M to 8M potassium hydroxide than in electrolytes without these components.

FIG. 4b shows a graph of the voltage at 150 mA per cm² in a 10 cell stack of aluminium-air fuel cells against the dissolved aluminate at 60° C. As can be seen, the voltage drops as the aluminate concentration increases. The voltage is found to be higher in electrolytes with 4M to 6M potassium hydroxide than in electrolytes without these components.

Whilst the electrolyte used in the examples given above is 4M, 6M or 8M potassium hydroxide, it will be appreciated that the electrolyte may comprise a compound selected from one or more of the group consisting of: group I hydroxides, including sodium hydroxide and potassium hydroxide; aluminium hydrate (hydrargyllite); and group I halides, including sodium chloride but excluding sodium fluoride.

Furthermore, whilst the electrolyte described comprises sodium fluoride as a seeding agent, further electrolyte compositions were prepared having various seeding agents including those selected from the group consisting of: group I phosphates, including sodium phosphate; group I sulphates, including sodium sulphate; group I halides, including sodium fluoride but excluding sodium chloride; and group I carbonates, including sodium bicarbonate.

In an alternative embodiment, an aluminium-air fuel cell as described herein but with conventional flat electrodes includes sodium fluoride as a seeding agent. Further electrolyte compositions were prepared having various seeding agents including those selected from the group consisting of: group I phosphates, including sodium phosphate; group I sulphates, including sodium sulphate; group I halides, including sodium fluoride but excluding sodium chloride; and group I carbonates, including sodium bicarbonate.

As the reaction proceeds, aluminate (Al(OH)₄⁻) builds up in the electrolyte. Aluminate is much less conductive than hydroxide (OH⁻) and therefore a build-up of dissolved aluminate creates a polarisation effect which reduces the working capacity of the cell. In order to mitigate this effect, seeding agents, precipitators and filters can be used to precipitate and filter alumina trihydrate, or hydrargyllite (Al₂O₃.3H₂O or Al(OH)₃) according to the following reaction:

### Precipitation of Hydrargyllite

NaAl(OH)₄→NaOH+Al(OH)₃

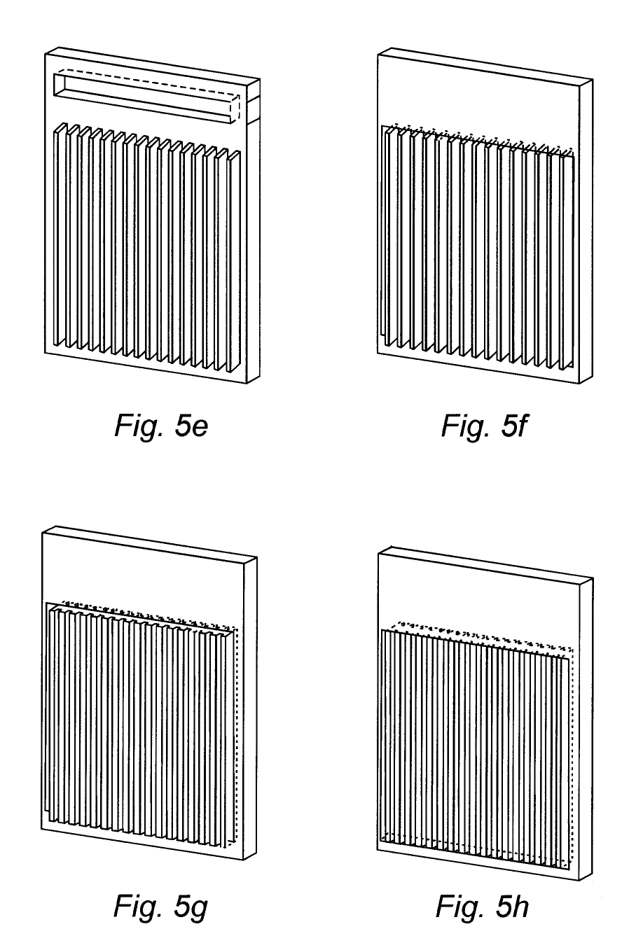

Referring now to FIGS. 5a to 5h, there is illustrated various aluminium electrodes of different design.

FIG. 5a shows an aluminium electrode with V-shaped grooves. The spacing between the grooves is about 5 mm, the width of the grooves is about 4 mm and the depth of the grooves is about 3 mm. The width may vary from about 1.5 mm to about 4 mm and the depth may vary from about 1.5 mm to about 3 mm.

FIG. 5b shows a ridged aluminium electrode. The ridges have a width of approximately 10 mm to 12 mm and a depth of about 4 mm.

FIG. 5c shows an aluminium electrode with score lines or incisions. The space between the score lines is approximately 4 mm to 5 mm, the width of the score lines is approximately 1 mm to 1.5 mm and the depth of the score lines is approximately 0.5 mm to 1 mm.

FIG. 5d shows an aluminium electrode with U-shaped grooves. The spacing between the grooves is about 5 mm, the width of the grooves is about 4 mm and the depth of the grooves is about 3 mm.

FIG. 5e shows an aluminium electrode with a blade-shaped structure. The distance between the blades is 2 mm to 5 mm and the width of the blades is about 5 mm to about 12 mm.

FIG. 5f shows an aluminium electrode with a louvered structure. The distance between the louvers is 2 mm to 5 mm and the width of the louvers is about 5 mm to about 12 mm.

FIG. 5g shows an aluminium electrode with a multiple rod structure. The distance between the rods is 2 mm to 3 mm and the width of the rods is about 2 mm to about 5 mm.

FIG. 5h shows an aluminium electrode with a wired structure. The distance between the wires is 2 mm to 3.5 mm and the width of the wires is about 0.5 mm to about 1.5 mm.

FIGS. 5a to 5h illustrate various examples of grooves and the like that can be made to the aluminium electrode. It can be seen from these examples that the width of the grooves and the like can vary from about 1 mm to about 12 mm, the depth of the grooves and the like can vary from about 0.5 mm to about 4 mm and that the distance between the grooves and the like can vary from between about 4 mm to about 5 mm.

Some of the aluminium electrodes described above have a “closed” structure (such as 5a, 5b, 5c and 5d) wherein there is no gap transcending the sides of the electrode. Others (such as 5e, 5f, 5g and 5h) have an at least partly open structure wherein there is a gap or orifice that transcends the sides of the electrode.

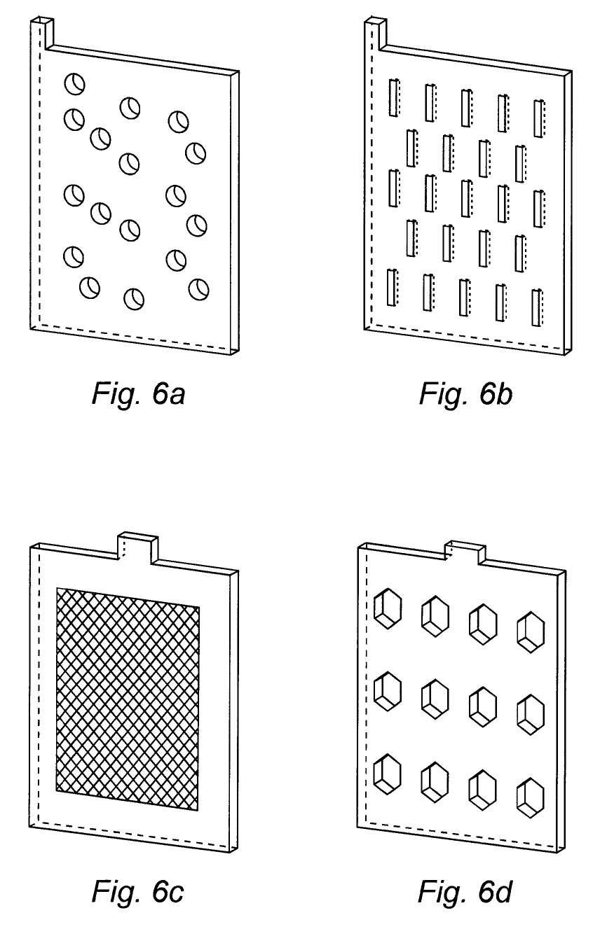

Further open structures are illustrated in FIGS. 6a to 6d as described below.

FIG. 6a shows an aluminium electrode having substantially circular apertures between the two sides of the electrode. The substantially circular apertures comprise from about 10% to about 12% of the area of one side of the electrode.

FIG. 6b shows an aluminium electrode having longitudinal slots between the two sides of the electrode. The longitudinal slots comprise from about 5% to about 10% of the area of one side of the electrode.

FIG. 6c shows an aluminium electrode having an open mesh in the centre, the mesh aperture being in the range 1.4 mm to 1.7 mm.

FIG. 6d shows an aluminium electrode having hexagonal-shaped apertures.

As can be seen from FIGS. 6a to 6d, the aluminium electrode may have one or more apertures, and in some cases has a plurality of apertures. Furthermore, whilst the slots in FIG. 6b are longitudinal, it will be appreciated that depending on the relative dimensions and the orientation of the electrode, the slots could also be latitudinal.

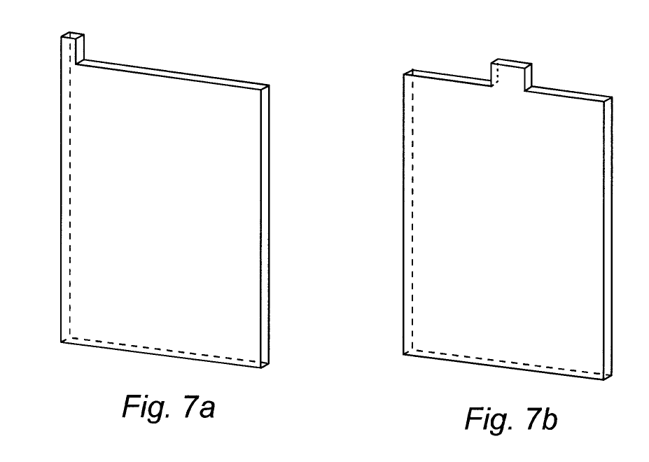

Comparative tests were carried out using the aluminium electrodes as described in FIGS. 6b (slotted electrode), 5b (ridged or corrugated electrode), 5d (U-shaped grooves) and 5a (V-shaped grooves), and the prior art standard flat electrode illustrated in FIG. 7a and the prior art standard spade electrode as illustrated in FIG. 7b.

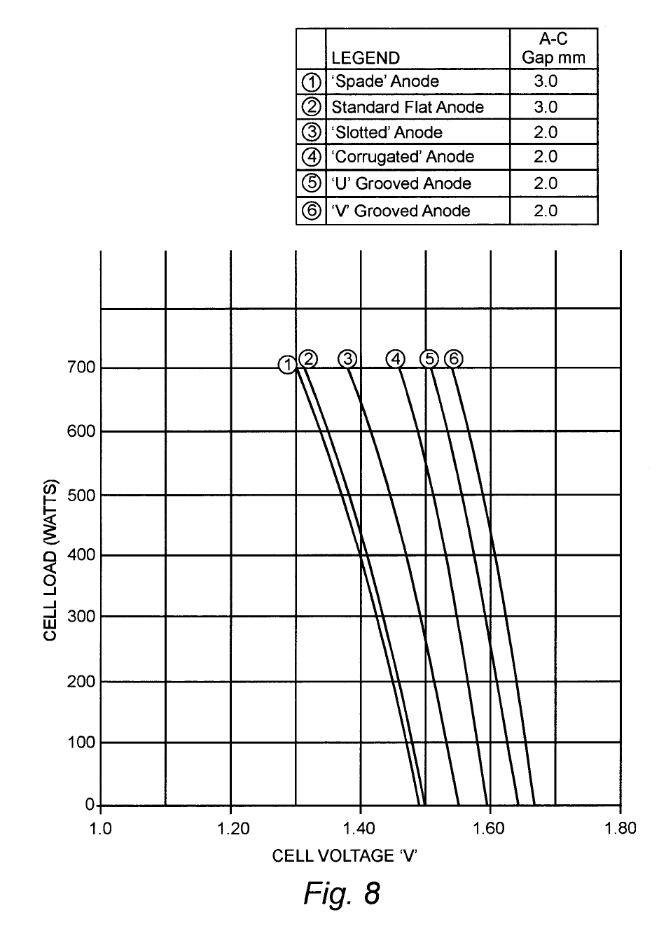

FIG. 8 shows a graph of the cell load (Watts) against the cell voltage (V) for the electrodes described above in 2M potassium hydroxide electrolyte. This graph illustrates the open circuit voltage (i.e., zero current flow) for the various electrodes. The results are summarised below in Table 1.

TABLE 1

| | Gas | | | | | |
|---|---|---|---|---|---|---|
| | dis- | | | | | |
| | engage- | | Uniform | | | |
| | ment | | current | | | |
| | at narrow | Electrolyte | dis- | Open- | On- | |
| | inter- | circulation | tribution | circuit | load | Battery |
| Anode | electrode | at narrow | at narrow | voltage | voltage | power |
| Type | gap | gap | gap | (V) | (V) | (W) |
| FIG. 7b | Poor | Poor | No | 1.49 | 1.31 | 695 |
| FIG. 7a | Poor | Poor | No | 1.50 | 1.33 | 700 |
| FIG. 6b | Good | Good | Yes | 1.54 | 1.38 | 704 |
| FIG. 5b | Good | Good | Yes | 1.59 | 1.46 | 700 |
| FIG. 5d | Good | Good | Yes | 1.64 | 1.51 | 702 |
| FIG. 5a | Good | Good | Yes | 1.67 | 1.54 | 700 |

It is clear from FIG. 8 and from Table 1 that the modified electrodes of the invention have improved gas disengagement, electrolyte circulation and current distribution at narrow inter-electrode gaps. This helps to mitigate polarisation. Furthermore, it is also shown that the modified electrodes have a higher open-circuit voltage and a higher on-load voltage than standard known electrodes. Clearly, this is advantageous as it enables a higher voltage to be achieved when the electrodes are included in a number of cells, said cells being arranged to form a battery.

The aluminium electrodes are made using standard casting, etching and machining processes known in the art. For example, the electrodes can be cast to a particular shape by pouring molten aluminium or alloy into a suitable mould, or by the “direct chillcast” process. Alternatively, the aluminium electrodes can be mechanically cut from an extruded strip or can be cut, drilled, engraved, marked or welded using lasers. In particular, in one embodiment of the invention, aluminium electrodes were prepared comprising a tin dopant and a further dopant selected from the group consisting of: gallium, indium, thallium and phosphorus. The tin dopant was present in an amount of 0.05% w/w, the indium in an amount of 0.045% w/w and the gallium in an amount of 0.026% w/w. Generally, the inventor has found that the inclusion of suitable dopants in an amount of up to around 700 ppm can increase the current density over a period of time. Various electrodes were made including those outlined in FIGS. 5a to 5h and 6a to 6d.

In one embodiment, traditional flat and spade-type electrodes were produced (i.e., electrodes without any grooves or the like or apertures) having various dopants added as indicated above.

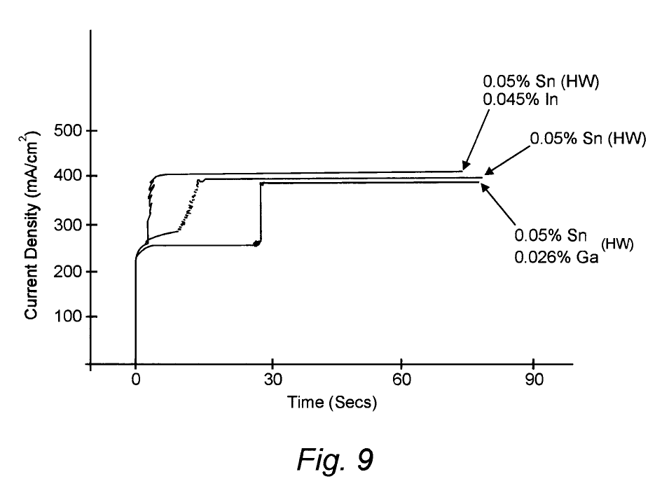

Referring now to FIG. 9, there is shown a graph of current density against time for aluminium electrodes doped with 0.05% w/w tin and 0.045% w/w indium; 0.05% w/w tin only; and 0.05% w/w tin and 0.026% w/w gallium. As can be seen from the graph, the inclusion of a tin and indium dopant increases the current density.

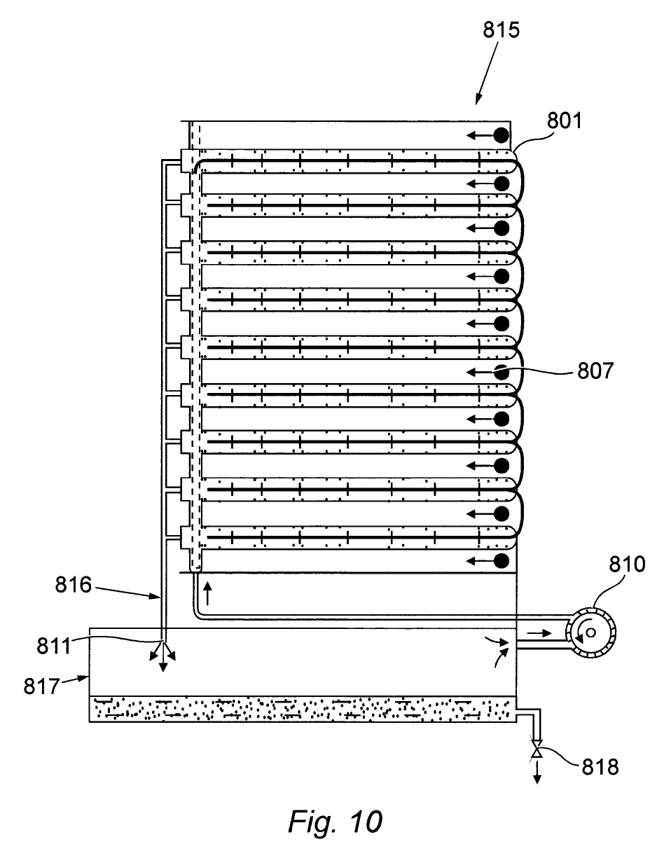

Referring now to FIG. 10, in one embodiment of the invention there is provided at 815 a battery comprising several aluminium air fuel cells 801 connected by a polypropylene feed manifold 816 through which electrolyte flows. The electrolyte is circulated using the pump 810 which takes electrolyte from the sump and settling tank 817 for circulation through the cells 801 via the manifold 816. The electrolyte returns to the reservoir via the electrolyte outlet/overflow 811. Also shown are several air supplies 807 for feeding air to the cells 801.

In the embodiment of the battery 815 as described above, hydrargyllite which forms in the electrolyte, precipitates and settles in the sump and settling tank 817 where is can be removed via drain 818.

In an alternative embodiment, the battery also includes a filter in fluid connection with the flow of the electrolyte, said filter being of a design to remove precipitated or suspended solids, in particular hydrargyllite. Suitable filters include cross-flow filters such as sintered metal cross-flow filters and Fibrotex® filters. Such filters suitably have a pore size of 2 to 3 microns and a surface area of 500 cm².

In a one embodiment, the battery as described above also includes a precipitator in fluid connection with the flow of the electrolyte, said precipitator being of a design to promote the precipitation of solids, in particular hydrargyllite, from the electrolyte. Suitable agents for promoting hydrargyllite precipitation are hydrargyllite seeding agents such as sodium fluoride. Other suitable seeding agents include those selected from the group consisting of: group I phosphates, including sodium phosphate; group I sulphates, including sodium sulphate; group I halides, including sodium fluoride but excluding sodium chloride; and group I carbonates, including sodium bicarbonate. The battery also includes a filter in fluid connection with the flow of the electrolyte, said filter being of a design to remove precipitated or suspended solids, in particular hydrargyllite. Suitable filters include cross-flow filters such as sintered metal cross-flow filters and Fibrotex® filters. Such filters suitably have a pore size of 2 to 3 microns and a surface area of 500 cm².

In another embodiment, the battery as described above is mounted on a frame or bracket assembly such that it can pivot up to approximately 180°. For example, the aluminium-air fuel cells can be arranged side-by-side (as shown, for example, in FIG. 10) to form a battery encased in an electrolyte chamber. The sides of the electrolyte chamber that run parallel to the sides of the cells can be fixed to a frame or bracket assembly by a pivotable fixing such that the entire battery can rotate about the axis of the fixing.

The pivoting of the battery allows the battery to be cleaned (i.e., removal of precipitates from a sump at the bottom of the battery) with reduced downtime.

In a further embodiment, a battery comprising aluminium-air fuel cells as described herein but with conventional electrodes includes a frame or bracket assembly such that it can pivot up to approximately 180°.

In another embodiment, a battery comprising aluminium-air fuel cells as described herein but with conventional electrodes includes a precipitator in fluid connection with the flow of the electrolyte, said precipitator being of a design to promote the precipitation of solids, in particular hydrargyllite, from the electrolyte. Suitable agents for promoting hydrargyllite precipitation are hydrargyllite seeding agents such as sodium fluoride. Other suitable seeding agents include those selected from the group consisting of: group I phosphates, including sodium phosphate; group I sulphates, including sodium sulphate; group I halides, including sodium fluoride but excluding sodium chloride; and group I carbonates, including sodium bicarbonate.

In another embodiment, a battery comprising aluminium-air fuel cells as described herein but with conventional electrodes includes a filter in fluid connection with the flow of the electrolyte, said filter being of a design to remove precipitated or suspended solids, in particular hydrargyllite. Suitable filters include cross-flow filters such as sintered metal cross-flow filters and Fibrotex® filters. Such filters suitably have a pore size of 2 to 3 microns and a surface area of 500 cm².

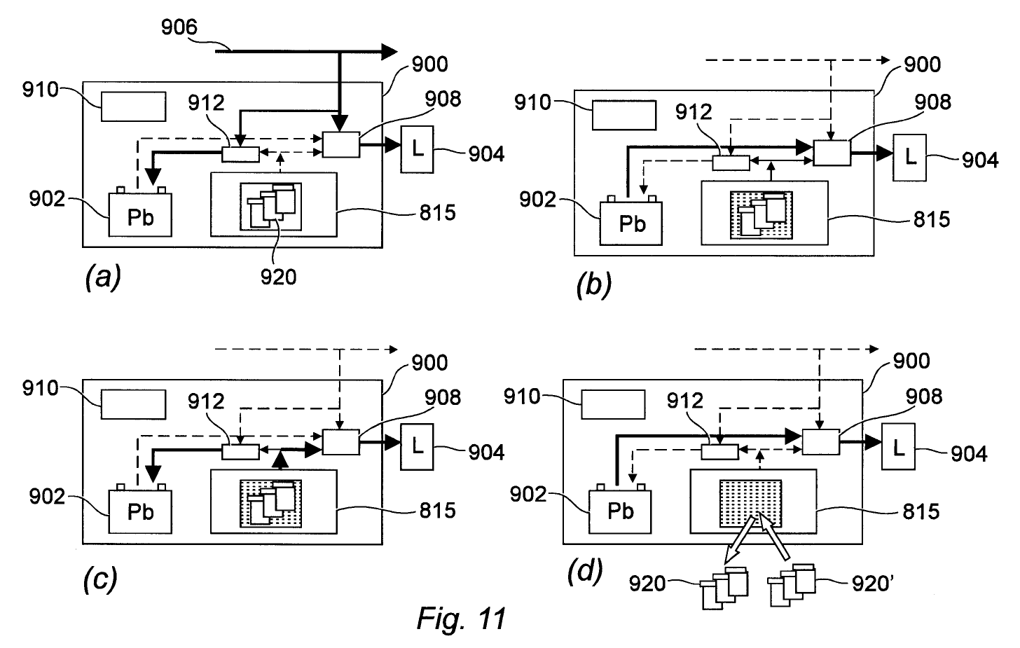

FIG. 11 illustrates a self-contained power module incorporating battery 815 and a reserve power source 902 which may conveniently be in the form of a conventional lead acid battery or other rechargeable/replaceable battery. In use, the battery may act as a back-up power supply for a load 904, which is activated when a main power supply 906 fails. The module can equally serve as a standalone power supply where no main supply is available. The module may be provided in a transportable housing, for example a sub-unit of a standard shipping container, for deployment in emergency situations, and for convenience generally.

The battery 815 and the reserve power source 902 are connected to load 904 via a supply switching unit 908 which is controlled by a monitor-controller 910 which receives input signals from sensors and/or user input devices, not shown in the drawing. Sensors will be provided for measuring voltages and currents at points in the system, also for monitoring temperature of electrolyte and other parts, and for detecting fault conditions.

Switching unit 908, which may include DC-DC, DC-AC or AC-DC conversion functions as desired, is operable to supply load 904 from main supply 906 (where present), from battery 815, and from reserve power source 902. Both the battery 815 and the reserve power source 902 can supply the load simultaneously if necessary. In this embodiment, the battery 815 can be operated in the horizontal or vertical planes. A charging unit 912 is provided for charging the reserve power source 902 from main supply 906 or from battery 815, under control of controller 910. Any of the components can be provided in redundant pairs for additional integrity of the supply.

Parts (a) to (d) of FIG. 11 show the module 900 in different modes of operation, as will now be described. In these diagrams, dashed lines indicate inactive connections, heavy solid lines indicate power supply to the load 904, and lighter solid lines indicate charging supply to reserve power source 902.

In FIG. 11(a), we see an initial condition in which battery 815 is inactive, and load 904 is powered from main supply 906. The failure of the main power supply 906 triggers controller 910 to activate the battery 815 via, for example, a relay thereby providing an activation mechanism. Within battery 815, we see schematically the anodes which are out of contact with electrolyte in FIG. 11(a), and are immersed in electrolyte in FIG. 11(b). Reserve source 902 provides power for the activation mechanism. On start-up, the battery may run in unison with reserve source 902, as shown in FIG. 11(b), until such time that the battery attains an optimum operating temperature of 40° C. to 65° C. A preferable operating temperature is 50° C. to 65° C. Once fully operating (FIG. 11(c)), supply to load 904 is entirely from battery 815, and a charging current is provided to replenish reserve source 902 also.

Note that activation of battery 815 can be delayed for a period after main power supply 906 has failed, to avoid wasting the aluminium anodes in the event that main supply 906 is interrupted for a period so short that reserve source 902 can support the load for the entire interruption. For example, reserve source 902 may have capacity to supply load 904 for 2 hours, while battery 815 can supply load 904 for 48 hours on one set of anodes. Provided the charge in reserve source 902 remains sufficient to power the load until the battery 815 is up to full power, the activation of battery 815 can be deferred by controller 910.

The battery is operated by providing an air flow to the air cathode at, for example, 1 to 3 litres per minute through a single cell at a pressure of 1 to 7 Pascals. The air usage corresponds to between 4 and 10 times the stoichiometric oxygen consumption rate. A flow of electrolyte is provided and maintained at a flow rate of between 0.5 and 2.5 litres per minute at a Reynolds number between 300 and 1000 (i.e., laminar flow).

In one embodiment, the flow of electrolyte is oscillated thereby inhibiting flocculation of the precipitates that form therein.

The output of the battery is monitored and when it drops below a predetermined threshold value, the battery is shut down and reserve power source 902 is used again to supply load 904 (FIG. 11(d)). The aluminium electrodes 920 can then be replaced with new electrodes 920′ before the aluminium-air fuel cell battery is restarted using the lead acid reserve battery (FIG. 11(b) again). At any time that the aluminium-air battery is operational, the lead acid battery can be being recharged (FIG. 11(c) again). Naturally if main supply 906 is restored, operation reverts to the state shown in FIG. 11(a).

The lead acid battery thus acts as a reserve power source that allows continuous supply to the load for days or weeks, so long as fresh electrodes are to hand when needed. Reserve source 902 may, for example, be used to pre-heat the electrolyte to accelerate the activation process.

The battery as described herein can contain a bank of from, for example, 20 to 40 aluminium-air fuel cells connected in series and connected to an electrolyte reservoir. It may also contain a heat exchanger and/or a cooling mechanism which removes heat from the cells (in particular from the electrolyte) to ensure that the battery does not overheat. Specifically, the temperature of the electrolyte should not be allowed to exceed 75° C. Such heat exchangers are well known in the field of fuel cells.

A battery having up to 20 cells can provide for 50 hours at 700 Watts approximately 35 kWh at a voltage of around 30 to 35 volts. If higher peaks of power are required, this is achieved by increasing the number of cells connected in series.

The battery normally operates at 50° C. to 65° C. and gives a cell voltage typically greater than 1.6 volts at a current density of 150 mA per cm². Full power is generally only available once the electrolyte reaches 35° C. to 40° C., which generally occurs after around 15 minutes. This delay can be reduced significantly by pre-heating the electrolyte which is fed to the battery.

When the battery power wanes, the aluminium electrodes are substantially consumed, and the battery is ready for mechanical regeneration (i.e., anode replacement). At this point the monitoring unit 910 will shut down the battery. The monitoring unit will also monitor the battery when dormant. Typically, the monitoring unit will monitor voltage output from the battery and will be equipped with relays and the like for switching the battery on/off as appropriate. The monitoring unit may also monitor the electrolyte temperature and may activate a temperature control system.

The developments of aluminium electrodes, aluminium-air fuel cells and batteries as described herein represents a significant improvement over the prior art. In particular, the modified aluminium electrodes described reduce the polarisation effects which would ordinarily make such batteries commercially unattractive. Furthermore, the electrolyte management described reduces the build up of aluminate in the electrolyte, thus improving the voltage, current and lifetime of the cell. Batteries assembled from fuel cells of the type described herein have potential utility in electric vehicles and in back-up power supplies. In particular, the batteries can be used in emergency aid containers, providing power to disaster struck and/or remote areas.

Various modifications and variations to the described embodiments of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the art are intended to be covered by the present invention.

What is claimed is:

1. An aluminium electrode for use in conjunction with an aluminium-air fuel cell, the aluminium electrode comprising:
at least two long dimensions; and
at least two sides formed by the at least two long dimensions, wherein at least one side comprises at least one partially disrupted surface.

2. The aluminium electrode of claim 1, wherein the electrode comprises a wedge shape.

3. The aluminium electrode of claim 2, wherein the electrode comprises a top side and a bottom side, said top side comprising a greater width than said bottom side, thereby forming a wedge-shape.

4. The aluminium electrode of claim 3, wherein the electrode comprises at least one groove extending between the top side and the bottom side.

5. The aluminium electrode of claim 1, wherein the at least one side comprises at least one groove traversing the side.

6. The aluminium electrode of claim 4, further comprising a plurality of grooves extending between the top side and the bottom side.

7. The aluminium electrode of claim 5, wherein the plurality of grooves are substantially parallel.

8. The aluminium electrode of claim 4, wherein the at least one groove comprises a width of between about 1 mm to about 12 mm.

9. The aluminium electrode of claim 4, wherein the at least one groove comprises a depth of between about 0.5 mm to about 4 mm.

10. The aluminium electrode of claim 5, wherein the distance between the plurality of grooves is between about 4 mm to about 5 mm.

11. The aluminium electrode of claim 4, wherein the at least one groove comprises a V-shape.

12. The aluminium electrode of claim 11, wherein the at least one groove comprises a width of between about 1.5 mm to about 4 mm.

13. The aluminium electrode of claim 11, wherein the at least one groove comprises a depth of between about 1.5 mm to about 3 mm.

14. The aluminium electrode of claim 1, further comprising:
a first dopant comprising tin, and
a second dopant comprising at least one of the group consisting of: gallium, indium, thallium and phosphorus.

15. The aluminium electrode of claim 14 wherein the second dopant is present in an amount of up to approximately 0.05% w/w.

16. An aluminium-air fuel cell comprising:
an aluminium electrode comprising at least two sides, wherein at least one side comprises at least one partially disrupted surface; and
an electrolyte chamber comprising an aluminium anode and at least one air cathode.

17. The aluminium-air fuel cell of claim 16, wherein the electrolyte chamber comprises two air cathodes separated by a gap and wherein the at least one aluminium anode is located within the gap, and substantially parallel to the two air cathodes.

18. The aluminium-air fuel cell of claim 17, wherein the distance between the aluminium anode and either of the two air cathodes is between about 1 mm to about 2 mm.

19. The aluminium-air fuel cell of claim 17, further comprising two air distributors, wherein the two air distributors house the two air cathodes and the aluminium anode.

20. The aluminium-air fuel cell of claim 20, wherein the distance between the two air distributors and the adjacent air cathodes is between about 4 mm to about 5 mm.

21. The aluminium-air fuel cell claim 16, further comprising an electrolyte, the electrolyte comprising a compound comprising at least one of the group consisting of: group I hydroxides, including sodium hydroxide and potassium hydroxide; aluminium hydrate (hydrargyllite); and group I halides, including sodium chloride but excluding sodium fluoride.

22. The aluminium-air fuel cell claim 21, wherein the electrolyte further comprises a seeding agent comprising at least one of the group consisting of: group I phosphates, including sodium phosphate; group I sulphates, including sodium sulphate; group I halides, including sodium fluoride but excluding sodium chloride; and group I carbonates, including sodium bicarbonate.

23. The aluminium-air fuel cell of claim 21, wherein the electrolyte comprises at least one of the group comprising sodium hydroxide and potassium hydroxide, and comprises a concentration of between about 4M to about 8M.

24. A battery comprising:
at least two aluminium-air fuel cells, each aluminium-air fuel cell comprising:
an aluminium electrode comprising at least two sides, wherein at least one side comprises at least one partially disrupted surface; and
an electrolyte chamber comprising an aluminium anode and at least one air cathode.

25. The battery of claim 24, wherein each aluminium-air fuel cell further comprises a filter configured to remove suspended solids, said filter being fluidly connected to the electrolyte chamber.

26. The battery as claimed in claim 24, wherein each aluminium-air fuel cell further comprises a precipitator configured to precipitate hydrargyllite, said precipitator being fluidly connected to the electrolyte chamber.

27. The battery of claim 26, wherein the precipitator comprises a hydrargyllite seeding agent for promoting the precipitation of hydrargyllite.

28. The battery of claim 24, further comprising a reserve power source for providing power to a load while the aluminium-air fuel cells are inactive, and further comprising a charging mechanism configured to recharge the reserve power source using power supplied by the aluminium-air fuel cells, when active.

29. The battery of claim 29, further comprising an activation mechanism configured to activate the aluminium-air fuel cells to power said load, after a period of supplying power from the reserve power source.

30. The battery of claim 24, wherein the battery is configured to be pivotally mounted onto a mounting bracket assembly.
